(19) United States
(12) Patent Application Publication
(10) Pub. No.: US 2026/0316652 A1
(43) Pub. Date: Oct. 15, 2026

(54) CARGO LATCH ASSEMBLY FOR AN OFF-ROAD VEHICLE

(71) Applicant: BOMBARDIER RECREATIONAL PRODUCTS INC., Valcourt (CA)

(72) Inventors: Catherine GEOFFROY, Granby (CA); Francis GENDRON, Sherbrooke (CA); Charles DESPRÉS-NADEAU, Sherbrooke (CA)

(73) Assignee: BOMBARDIER RECREATIONAL PRODUCTS INC., Valcourt (CA)

(21) Appl. No.: 19/403,142

(22) Filed: Nov. 27, 2025

Related U.S. Application Data
(60) Provisional application No. 63/728,750, filed on Dec. 6, 2024.

(51) Int. Cl. B60P 1/28; B60K 13/04; B60K 17/16; B62D 33/023; B62D 61/10

(52) U.S. Cl. CPC B60P 1/283; B60K 13/04; B60K 17/16; B62D 33/023; B62D 61/10

(57) ABSTRACT

The present invention discloses a latching assembly for a cargo box for a vehicle, the latch assembly comprising an actuating portion configured to be actuated by a user, a latch portion configured to selectively engage a portion of a frame of the vehicle to selectively lock the cargo box on the vehicle in an operating position, and a transmission portion to operatively connect the actuating portion to the latch portion, wherein the actuating portion and the latch portion are spaced from one another in a longitudinal direction of the cargo box. Further the present invention discloses 6×6 vehicle comprising a frame, a front pair of ground-engaging members, an intermediate pair of ground-engaging members and a rear pair of ground-engaging members.

### CROSS-REFERENCE

The present application claims the benefit of U.S. Provisional Patent Applications Ser. No. 63/728,750 filed on Dec. 6, 2024, the content of which is herein incorporated by reference in its entirety.

### TECHNICAL FIELD

The present disclosure generally relates to cargo latch assemblies for off-road vehicles, specifically to cargo latch assemblies for off-road vehicles having at least six wheels.

### BACKGROUND

All-terrain vehicles (ATVs) commonly have four wheels and a straddle seat adapted to accommodate a driver of the vehicle. For some utilitarian uses (e.g., to provide additional storage space, additional traction and the likes), some ATVs have six wheels (in which case they are typically referred to as 6×6 vehicles or 6×6 ATVs).

6×6 ATVs typically comprise a cargo box disposed over two pairs of rear wheels, behind an operator seat and a latch assembly, the cargo box comprising a floor, side walls, a front wall and a tailgate. Some cargo boxes may be reconfigurable (i.e., the tailgate may be kept opened or closed, some of the front and side walls may be removed, etc.). The latch assembly can be used by an operator to switch the cargo box from a horizontal (or operational) configuration into an angled (or release) configuration.

Because their geometry and configurations are different, 6×6 ATVs are often designed and manufactured separately from 4×4 ATVs. However, these separate activities are resource-consuming.

For example, in 4×4 ATVs a handle of the latch assembly is preferably located at a front (or forward) end of the cargo box receiving area of the vehicle. In practice, the operator of the vehicle stands in front of the cargo box, rotates the handle to release a latch of the latch assembly, and optionally pushes the front end of the box upwards to move it in its release configuration.

Typical latch assemblies such as the ones found in 4×4 ATVs include a pair of handles rotatable on each lateral side of the vehicle, a straight rod extending between the handles, and one, two or three hooks configured to selectively engage bars of the frame based on a position of the handle. Latch assemblies such as the ones found in 4×4 ATVs are generally positioned under the cargo box, in a front (or forward) end of the cargo box receiving area of the vehicle.

However, prior art 6×6 ATVs have a configuration (e.g., a main frame structure, a layout of components such as an exhaust system, etc.) that is different from a configuration of a 4×4 ATV which, except for having four ground-engaging members, is otherwise similar. This adds complexity to the manufacturing of such vehicles.

Accordingly, there remains a need to provide latch assemblies and vehicles comprising such assemblies that alleviate at least some of the problems and shortcomings discussed above.

### BRIEF DESCRIPTION OF THE DRAWINGS

The accompanying drawings illustrate an embodiment of the present disclosure and, together with the description, serve to illustrate the principles of the present disclosure.

FIG. 1 shows a front perspective view of an off-road vehicle having a cargo box, in accordance with an embodiment;

FIG. 2 shows a rear perspective view of the off-road vehicle of FIG. 1, in accordance with an embodiment;

FIG. 3 shows a front perspective view of a latch assembly, in accordance with an embodiment;

FIG. 4 shows a front view of the latch assembly of FIG. 3, in accordance with an embodiment;

FIG. 5 shows a front rear of the latch assembly of FIG. 3, in accordance with an embodiment;

FIG. 6 shows a left view of the latch assembly of FIG. 3, in accordance with an embodiment;

FIG. 7 shows a right view of the latch assembly of FIG. 3, in accordance with an embodiment;

FIG. 8 shows a top view of the latch assembly of FIG. 3, in accordance with an embodiment;

FIG. 9 shows a bottom view of the latch assembly of FIG. 3, in accordance with an embodiment;

FIG. 10 shows an enlarged top view of the off-road vehicle of FIG. 1, without the cargo-box, in accordance with an embodiment;

FIGS. 11 to 13 show enlarged left perspective views of the off-road vehicle of FIG. 1, showing elements of the latch assembly of FIG. 3;

FIG. 14 shows an enlarged left perspective view of the off-road vehicle of FIG. 10, showing the latch assembly in a closed configuration;

FIG. 15 shows an enlarged left perspective view of the off-road vehicle of FIG. 10, showing the latch assembly in an intermediate configuration;

FIG. 16 shows an enlarged left perspective view of the off-road vehicle of FIG. 10, showing the latch assembly in an open configuration;

FIG. 17 shows a left side view of the off-road vehicle of FIG. 1 with the cargo box in an operational (or horizontal) configuration, in accordance with an embodiment;

FIG. 18 shows a left side view of the off-road vehicle of FIG. 1 with the cargo in an release (or angled) configuration, in accordance with an embodiment;

FIG. 19 shows an enlarged left perspective view of a frame of the off-road vehicle of FIG. 1 and having an upper connection portion and a lower connection portion, in accordance with an embodiment;

FIG. 20 shows an enlarged left perspective view of the upper connection portion of the frame of FIG. 1, in accordance with an embodiment; and

FIG. 21 shows an enlarged left perspective view of the lower connection portion of the frame of FIG. 1, in accordance with an embodiment.

It is understood that the drawings are for illustration only and are only intended to depict an embodiment of the present disclosure and therefore should not be considered as limiting.

### SUMMARY

In accordance with a broad aspect, there is provided a latching assembly for a cargo box for a vehicle, the latch assembly comprising an actuating portion configured to be actuated by a user, a latch portion configured to selectively engage a portion of a frame of the vehicle to selectively lock the cargo box on the vehicle in an operating position, and a transmission portion to operatively connect the actuating portion to the latch portion, wherein the actuating portion and the latch portion are spaced from one another in a longitudinal direction of the cargo box.

In accordance with an embodiment, the actuating portion comprises at least one handle.

In accordance with an embodiment, the actuating portion comprises two handles.

In accordance with an embodiment, the actuating portion is positioned in a vicinity of a front portion of the cargo box.

In accordance with an embodiment, the actuating portion is positioned above a pair of ground engaging members of the vehicle.

In accordance with an embodiment, the pair of ground engaging members of the vehicle is an intermediate pair of ground engaging members, the intermediate pair of ground engaging members being positioned rearward from a front pair of ground engaging members and forward from a rear pair of ground engaging members along a longitudinal direction of the vehicle.

In accordance with an embodiment, the actuating portion is positioned behind a seat of an operator of the vehicle.

In accordance with an embodiment, the transmission portion comprises a rod extending generally laterally between a left side and a right side of the vehicle.

In accordance with an embodiment, the transmission portion is affixed to the actuating portion.

In accordance with an embodiment, the transmission portion comprises at least one lever affixed to the rod.

In accordance with an embodiment, the transmission portion comprises two levers affixed to the rod.

In accordance with an embodiment, the transmission portion further comprises a link connected to the at least one lever.

In accordance with an embodiment, the link extends longitudinally toward a rear section of the cargo box.

In accordance with an embodiment, the link is connected to a cam.

In accordance with an embodiment, the cam comprises the latch portion.

In accordance with an embodiment, the latch assembly further comprises a spring.

In accordance with an embodiment, the cargo box is pivotally connected to the frame of the vehicle at a rear end portion of the cargo box.

In accordance with an embodiment, the latch assembly enables pivotal movement of the cargo box relative to the frame of the vehicle.

In accordance with an embodiment, the vehicle further comprises a cylinder connecting the cargo box to the frame.

In accordance with an embodiment, the vehicle comprises at least 6 ground engaging members.

In accordance with an embodiment, the vehicle is an ATV.

In accordance with an embodiment, the vehicle is a SSV.

In accordance with another broad aspect, there is provided a use of the preceding latch assembly in a vehicle.

In accordance with an embodiment, the vehicle comprises at least 6 ground engaging members.

In accordance with an embodiment, the vehicle is an ATV.

In accordance with an embodiment, the vehicle is a SSV.

In accordance with another broad aspect, there is provided a 6×6 vehicle comprising a frame, a front pair of ground-engaging members, an intermediate pair of ground-engaging members and a rear pair of ground-engaging members, the frame comprising: (i) a main portion extending from a front of the vehicle to the intermediate pair of ground-engaging members; and (ii) a rear portion extending from the intermediate pair of ground-engaging members to the rear pair of ground-engaging members. The main portion and the rear portion are affixed to one another through a connection portion, the connection portion comprising an upper connection portion and a lower connection portion, and wherein the main portion supports a drivetrain, a rear differential, an exhaust system comprising a muffler and an exhaust outlet, and a suspension system of the intermediate pair of ground-engaging members, wherein at least one component of the drivetrain, the rear differential, the exhaust system and the suspension system of the intermediate pair of ground-engaging members is adjacent and at least partly in front of the upper connection portion.

In accordance with an embodiment, the upper connection portion comprises a left upper connection portion and a right upper connection portion spaced from the left upper connection portion in a lateral direction of the 6×6 vehicle, and the component spans at least 90% of a lateral distance between the left upper connection portion and the right upper connection portion.

In accordance with an embodiment, the component is at least partly rearward from the lower connection portion.

In accordance with an embodiment, the component is entirely rearward from the lower connection portion.

In accordance with an embodiment, the component is a muffler.

In accordance with an embodiment, the 6×6 vehicle further comprises a latch assembly and a cargo box, wherein the cargo box, in an operating position, is at least partly above the component.

In accordance with an embodiment, the latch assembly comprises an actuating portion configured to be actuated by a user, a latch portion configured to selectively engage a portion of the frame of the vehicle to selectively lock the cargo box on the vehicle in the operating position, and a transmission portion to operatively connect the actuating portion to the latch portion, wherein the actuating portion and the latch portion are spaced from one another in a longitudinal direction of the cargo box.

In accordance with an embodiment, the actuating portion comprises at least one handle.

In accordance with an embodiment, the actuating portion comprises two handles.

In accordance with an embodiment, the actuating portion is positioned in a vicinity of a front portion of the cargo box.

In accordance with an embodiment, the actuating portion is positioned above the pair of intermediate ground-engaging members.

In accordance with an embodiment, the pair intermediate of ground-engaging members is positioned rearward from the front pair of ground-engaging members and forward from the rear pair of ground-engaging members along a longitudinal direction of the vehicle.

In accordance with an embodiment, the actuating portion is positioned behind a seat of an operator of the vehicle.

In accordance with an embodiment, the transmission portion comprises a rod extending generally laterally between a left side and a right side of the vehicle.

In accordance with an embodiment, the transmission portion is affixed to the actuating portion.

In accordance with an embodiment, the transmission portion comprises at least one lever affixed to the rod.

In accordance with an embodiment, the transmission portion comprises two levers affixed to the rod.

In accordance with an embodiment, the transmission portion further comprises a link connected to the at least one lever.

In accordance with an embodiment, the link extends longitudinally toward a rear section of the cargo box.

In accordance with an embodiment, the link is connected to a cam.

In accordance with an embodiment, the cam comprises the latch portion.

In accordance with an embodiment, the latch assembly further comprises a spring.

In accordance with an embodiment, the cargo box is pivotally connected to the frame of the vehicle at a rear end portion of the cargo box.

In accordance with an embodiment, the latch assembly enables pivotal movement of the cargo box relative to the frame of the vehicle.

In accordance with an embodiment, the vehicle further comprises a cylinder connecting the cargo box to the frame.

In accordance with an embodiment, the vehicle is an ATV.

In accordance with an embodiment, the vehicle is a SSV.

### DETAILED DESCRIPTION

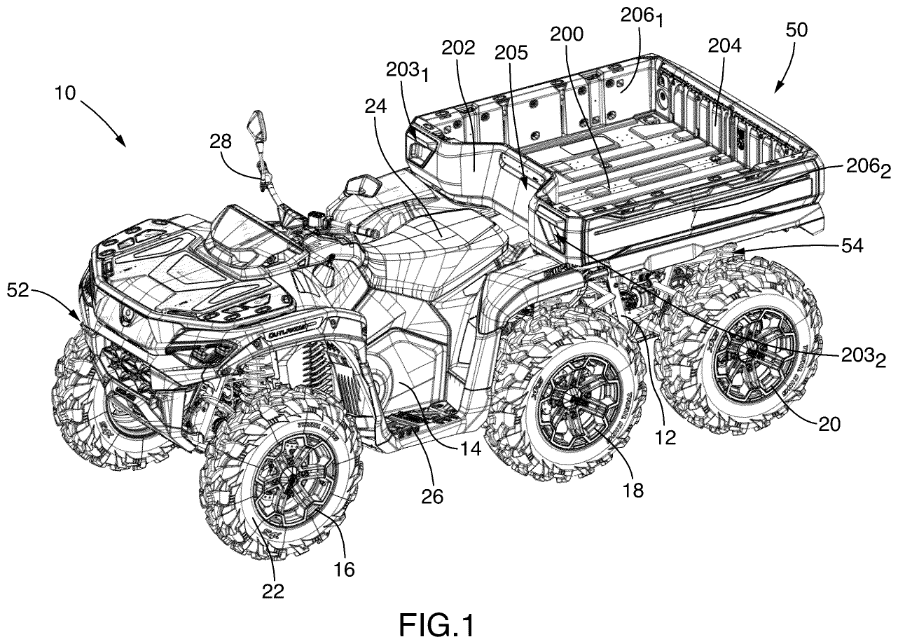

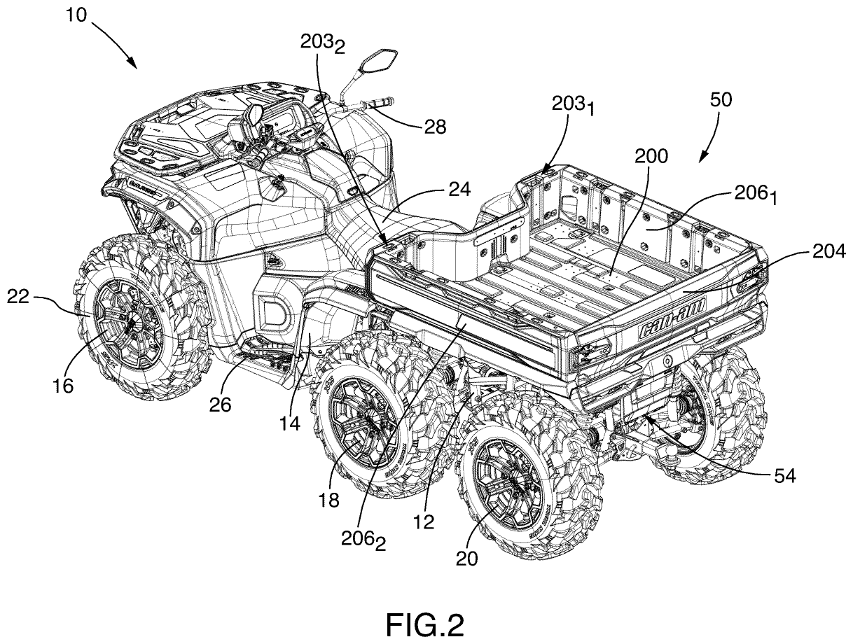

In one embodiment, and with reference to FIGS. 1 and 2, there is provided an off-road vehicle 10 having one or more straddle seats and a plurality of ground-engaging members (e.g., wheels), as further described below. In a non-limiting example, the off-road vehicle is an all-terrain vehicle (also referred to as “ATV”) having six wheels. However, it will be readily appreciated that at least some aspects of the present disclosure could be used on other types of off-road vehicles having six wheels, such as, for example, side-by-side vehicles (also referred to as “SSVs” or “UTVs”).

In the embodiment of FIGS. 1 and 2, the off-road vehicle 10 has a frame 12 to which a vehicle body 14 is mounted. The off-road vehicle 10 can be characterized by a longitudinal direction (generally extending between—and perpendicular to—the rear and the front portions of the off-road vehicle 10) and a lateral direction (generally extending between- and perpendicular to-the left and side portions of the off-road vehicle 10). Two front wheels 16 are suspended from a front of the frame 12. Two intermediate wheels 18 are suspended from the frame 12 rearward of the front wheels 16 (along a longitudinal direction of the off-road vehicle 10). Two rear wheels 20 are suspended from the frame 12 rearward of the intermediate wheels 18 (along a longitudinal direction of the off-road vehicle 10). In this embodiment, the longitudinal distance between the intermediate and rear wheels 18, 20 is less than the longitudinal distance between the front and intermediate wheels 16, 18. Each of the six wheels 16, 18, 20 of the off-road vehicle 10 has a tire 22. A straddle seat 24 is mounted on the frame 12 to accommodate a driver of the off-road vehicle 10 and at least a portion of the seat 24 is disposed between the front wheels 16 and the intermediate wheels 18 in a longitudinal direction of the off-road vehicle 10. Foot rests 26 are provided on either side of the seat 24, below the seat 24. Each foot rest 26 is disposed longitudinally between the front wheel 16 and the intermediate wheel 18 on the respective side of the off-road vehicle 10.

A steering assembly including a handlebar 28 is disposed forwardly of the straddle seat 24. A throttle lever and a brake lever (not shown) are mounted to the handlebar 28. The steering assembly is operatively connected to the two front wheels 16 to permit steering of the off-road vehicle 10. A motor (not shown) is mounted to the frame 12 below the straddle seat 22. In some non-limiting examples, the motor is a four-stroke, dual cylinder, V-type, internal combustion engine (ICE), however any other suitable motor could be used in other non-limiting examples such as, but not limited to, a two-stroke ICE, a diesel engine, an electric motor and the likes. The motor is operatively connected to the six wheels 16, 18, 20 to power the off-road vehicle 10. A gear selection lever (not shown) is provided below the handlebar 28 forward of the seat 24. A fuel filler cap (not shown) is provided on the vehicle body 14 to a right of a rear portion of the seat 24. Still in this embodiment, a cargo box 50 is mounted to the frame 12 of the off-road vehicle 10 rearward of the straddle seat 24, as further described below.

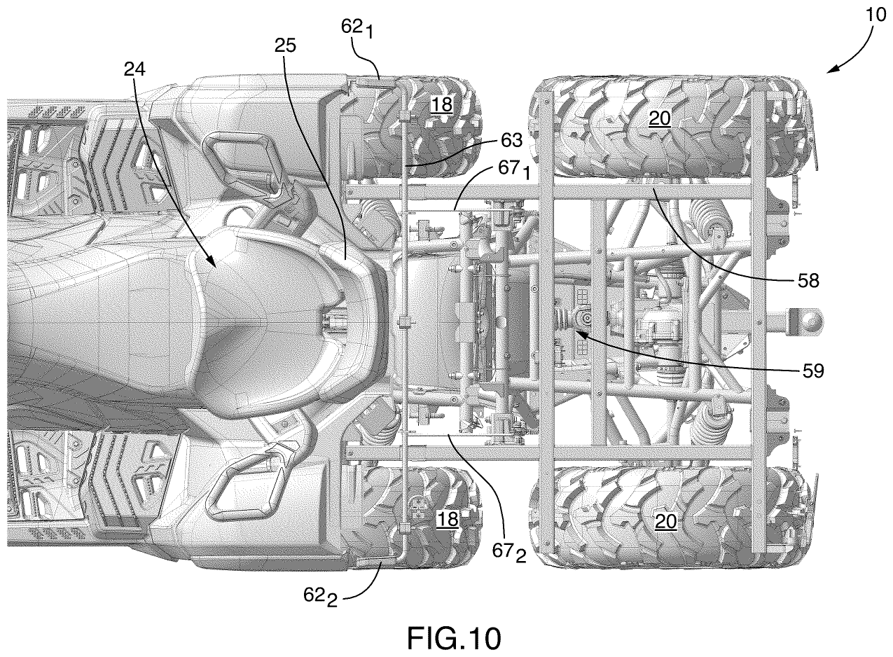

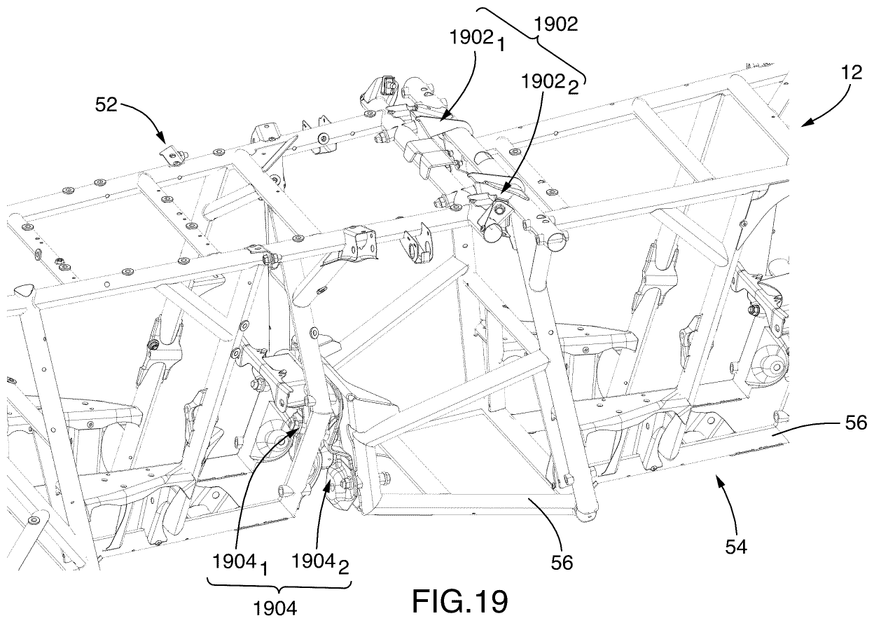

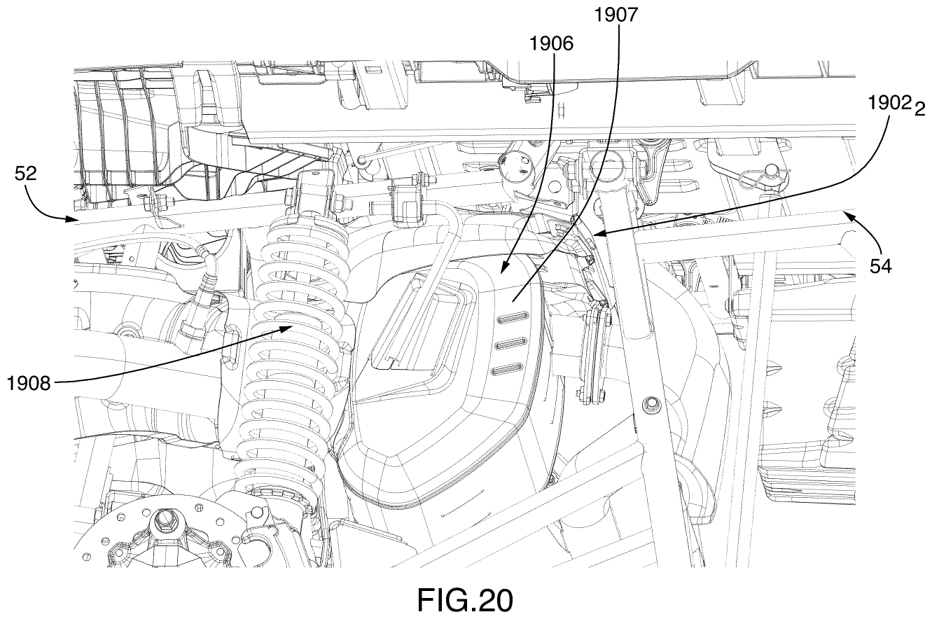

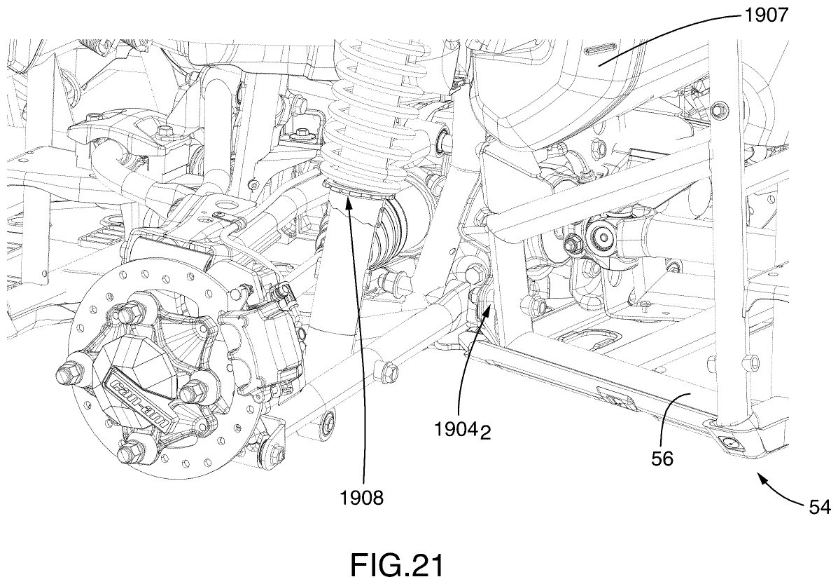

With reference to FIGS. 10 and 18 to 21, the frame 12 of the off-road vehicle 10 has a main frame portion 52 and a rear frame portion 54, the main frame portion 52 and the rear frame portion 54 being affixed to each other. The main frame portion 52 and the rear frame portion 54 may be affixed to each other using any suitable means (e.g., the main frame portion 52 and the rear frame portion 52 may be screwed, bolted, etc., as further described below) The front and intermediate wheels 16, 18 are connected to the main frame portion 52. Specifically, the main frame portion 52 extends longitudinally from the front wheels 16 to the intermediate wheels 18 of the off-road vehicle 10. The rear frame portion 54 extends longitudinally from the intermediate wheels 18 to the rear wheels 20 of the off-road vehicle 10, and the rear frame portion 54 comprises a plurality of lower longitudinally extending frame members 56 to which the rear wheels 20 are connected. Still in this embodiment, front regions of the frame members 56 are connected to the main frame portion 52. The rear frame portion 54 also defines a space 59 to receive the cargo box 50 therein, as further described below.

It will be readily appreciated that the main frame portion 52 of the frame 12, to which the front and intermediate wheels 16, 18 are connected, shares the same structure (i.e., the same configuration, components, etc.) as the frame of a 4×4 ATV, the rear frame portion 54 being supported by the rear wheels 20 and affixed to the main frame portion 52 of the frame 12. Still in this embodiment, the main frame portion 52 and the rear frame portion 54 are affixed to each other via a connection portion comprising an upper connection portion 1902 (specifically, a right upper connection portion 1902₁ and a left upper connection portion 1902₂) and a lower connection portion 1904 (specifically, a right lower connection portion 1904₁ and a left lower connection portion 1904₂). The right upper connection portion 1902₁ and the left upper connection portion 1902₂ are spaced from each other along a lateral direction of the off-road vehicle 10. The right lower connection portion 1904₁ and the left lower connection portion 1904₂ are also spaced from each other along the lateral direction of the off-road vehicle 10. In this embodiment, the right upper connection portion 1902₁ and the left upper connection portion 1902₂ are generally positioned rearward from the lower connection portion 1904 along the longitudinal direction of the off-road vehicle 10. Similarly, the right lower connection portion 1904₁ and the left lower connection portion 1904₂ are generally positioned forward from the upper connection portion 1902 along the longitudinal direction of the off-road vehicle 10.

The off-road vehicle 10 has other features and components common to most off-road vehicles such as headlights, a fuel tank (not shown), an air intake system (not shown), a drivetrain (not shown), a rear differential (not shown), an exhaust system 1906 comprising a muffler 1907 and an exhaust outlet, and a suspension system, including a suspension system 1908 of the intermediate wheels 18. In this embodiment, the main frame portion 52 of the frame 12 supports the drivetrain, the rear differential, the exhaust system 1906 comprising the muffler 1907 and the exhaust outlet, and the suspension system 1908 of the intermediate wheels 18. As it is believed that these features and components would be readily recognized by one of ordinary skill in the art, further explanation and description of these components will not be provided herein. In addition, regarding the powertrain, the suspension system as well as drive and gear assemblies of the off-road vehicle 10, these systems and assemblies are similar to the ones shown and described in U.S. Pat. No. 9,555,702, issued Jan. 31, 2017, which is incorporated herein by reference.

In this embodiment, at least one component of the drivetrain, the rear differential, the exhaust system 1906 and the suspension system 1908 of the intermediate wheels 18 is generally positioned at least partly adjacent to, and in front of, at least one of the right upper connection portion 1902₁ and the left upper connection portion 1902₂ along the longitudinal direction of the off-road vehicle 10. The at least one component of the drivetrain, the rear differential, the exhaust system 1906 and the suspension system 1908 of the intermediate wheels 18 is also generally positioned at least partly rearward from the lower connection portion 1904. In some embodiments, the at least one component spans at least 90% of a lateral distance between the right upper connection portion 1902₁ and the left upper connection portion 1902₂. In some non-limiting examples, the component is the muffler 1907 of the exhaust system 1906 positioned at least partly in front of the right upper connection portion 1902₁ and the left upper connection portion 1902₂, and entirely rearward from the lower connection portion 1904.

As further described below, in this embodiment the cargo box 50 is selectively moveable (i.e., rotatable) relative to the frame 12 of the off-road vehicle 10, specifically relative to the rear frame portion 54 of the off-road vehicle 10.

The cargo box 50 has a cargo box base 200, a front wall 202, a rear wall (or tailgate) 204, and two side walls 206₁₋₂ (the side wall 206₁ being a right side wall, and the side wall 206₂ being a left side wall). The front wall 202 defines two generally planar (and substantially vertical/lateral) regions 203₁₋₂ of the front wall 202 (the region 203₁ being a right region and the region 203₂ being a left region), the two regions 203₁₋₂ being separated by a generally recessed region 205 along a lateral direction of the cargo box 50/off-road vehicle 10, the recessed region 205 being configured to provide space to a user when the user sits in the seat 24 of the off-road vehicle 10.

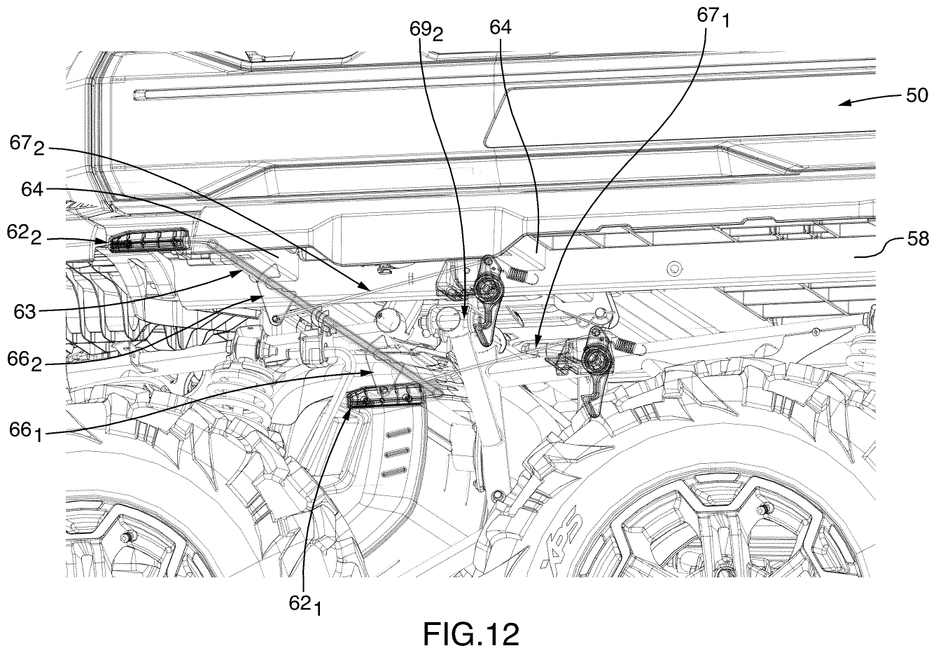

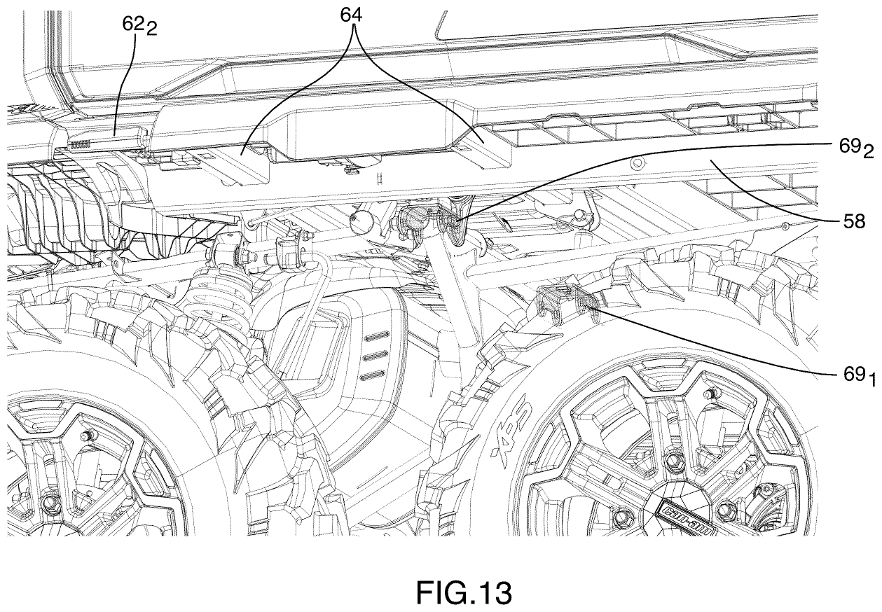

The cargo box 50 is supported by, and secured to, a cargo box supporting frame 58 (better shown in FIGS. 10 to 13) which is also selectively moveable (i.e., rotatable) relative to the frame 12 of the off-road vehicle 10), as further described below. The cargo box 50 is configured to be received within the space 59 defined by the rear frame portion 54 (i.e., in this embodiment the cargo box 50 generally extends longitudinally over the two rear wheels 20 and over at least a portion of the two intermediate wheels 18).

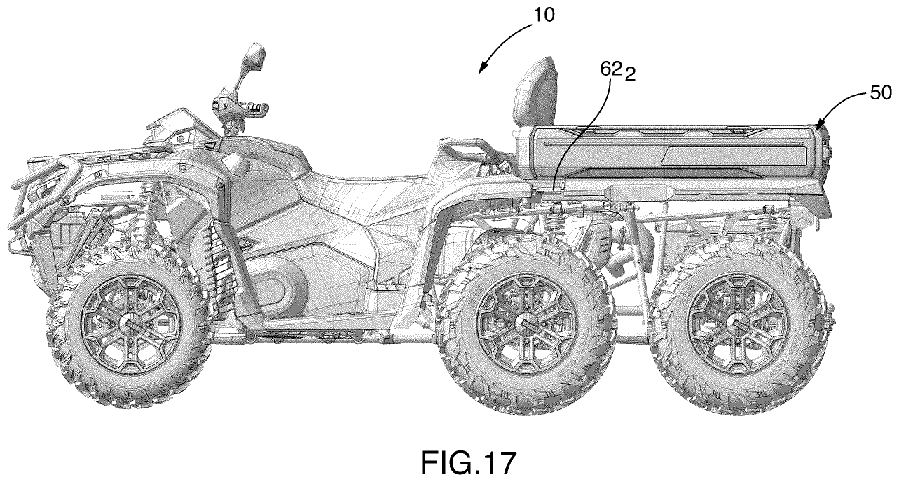

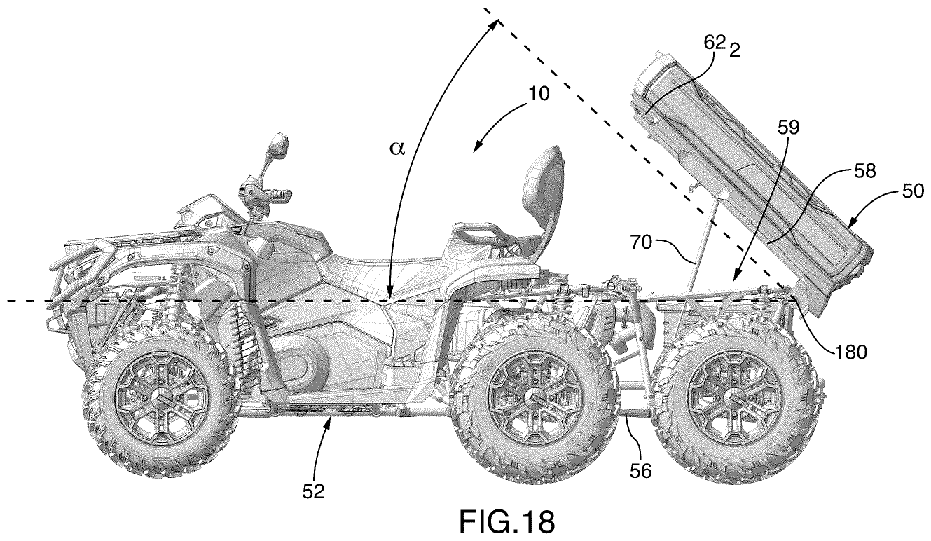

With further reference to FIGS. 17 and 18, the cargo box 50 (including the cargo box supporting frame 58) is pivotably mounted relative to the frame 12 of the off-road vehicle 10 (i.e., relative to the rear frame portion 54). In other words, the cargo box 50 is selectively moveable between various configurations, and which can be characterized by an angle between the base 200 of the cargo box 50 and a horizontal plane of the off-road vehicle 10 coextensive with a pivot axis of the cargo box 50, as further described below (this angle is 0° in FIG. 17 and α in FIG. 18).

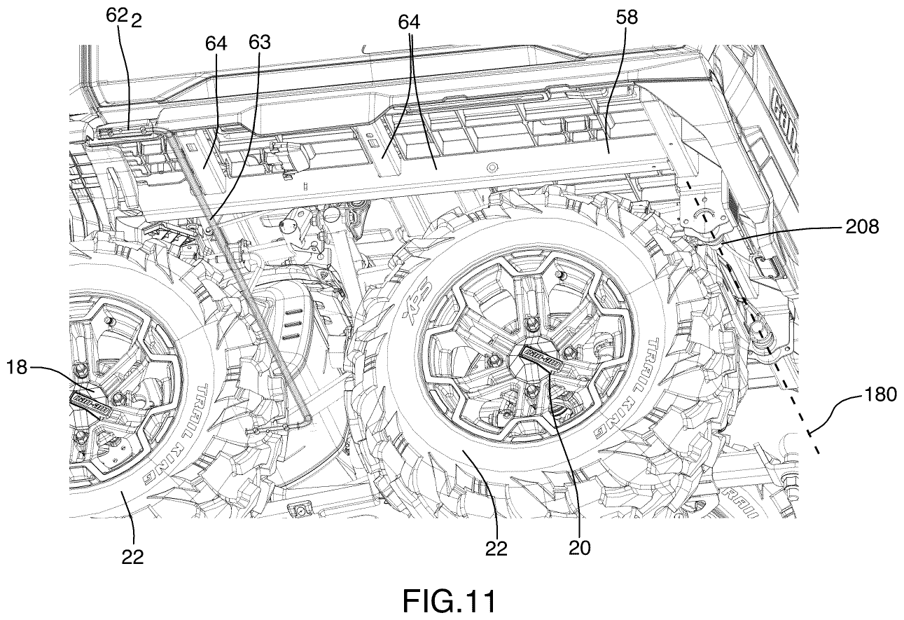

The cargo box 50 is pivotably moveable relative to the rear frame portion 54 via shafts 208 (better seen in FIG. 11). The shafts 208 define a pivot axis 180 between the cargo box 50 and the frame 12, the pivot axis 180 extending generally laterally at a rear end of the cargo box 50/frame 12 of the off-road vehicle 10, specifically rearward an axis of rotation of the rear wheels 20.

In the configuration of FIG. 17, the cargo box 50 is in a horizontal (or operational) configuration, which can be used when the off-road vehicle 10 is in motion. In FIG. 18, the cargo box 50 is in an angled (or release) configuration, which can be used when the off-road vehicle 10 is still to assist a user of the off-road vehicle 10 in emptying the cargo box 50.

To facilitate pivoting the cargo box 50 around the pivot axis 180, the off-road vehicle 10 may optionally further comprise a cylinder 70 between the cargo box 50 and the frame 12, forward to the pivot axis 180 along a longitudinal direction of the off-road vehicle 10. In some non-limiting embodiments, the cylinder 70 may be spring loaded to facilitate lifting and/or closing the cargo box 50 (i.e., moving the cargo box 50 from the horizontal (or operational) configuration to the angled (or release) configuration, and vice versa).

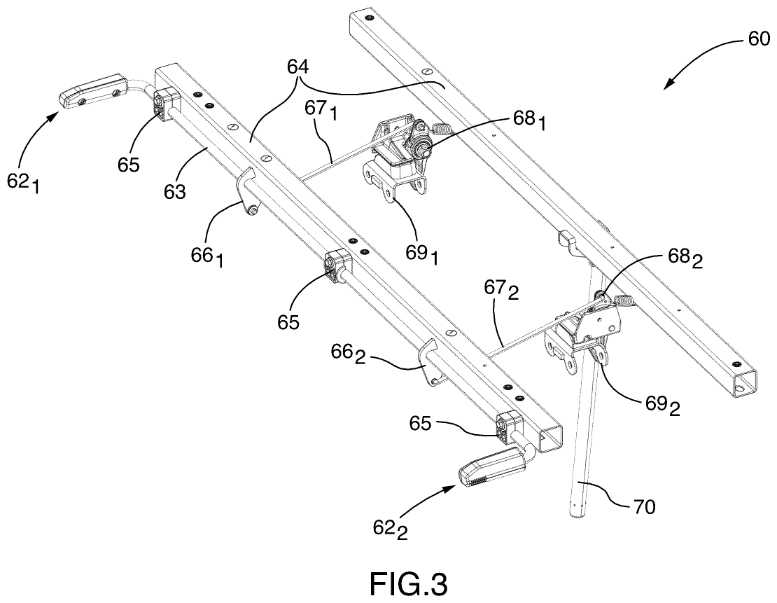

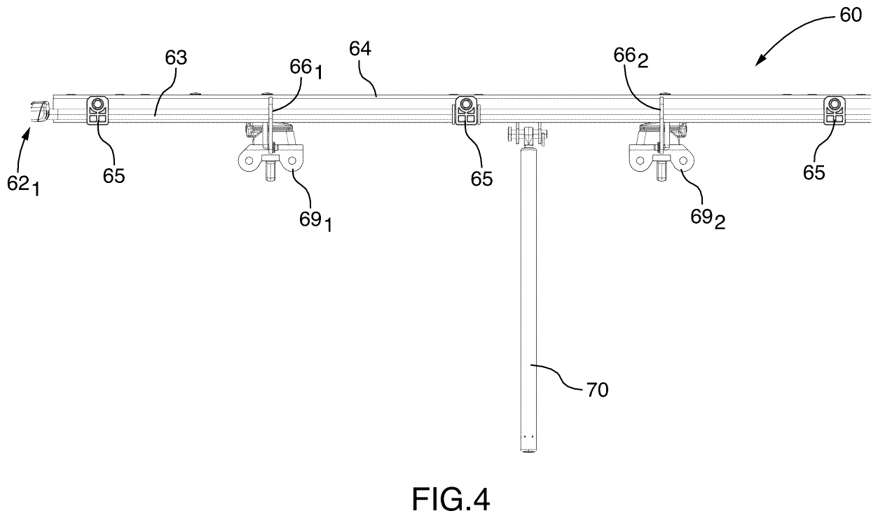

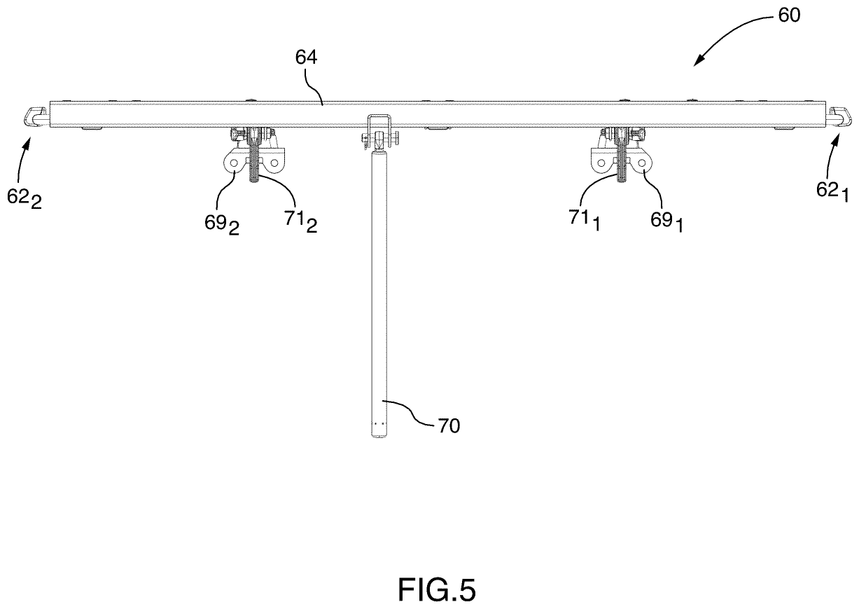

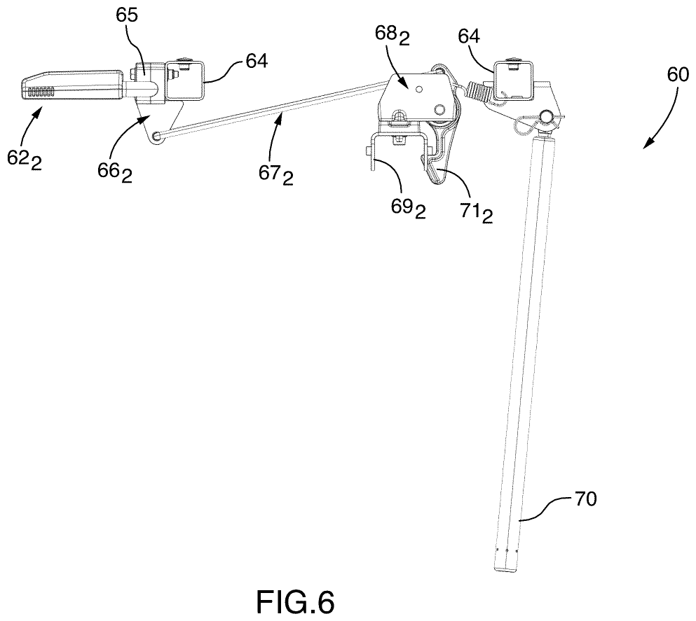

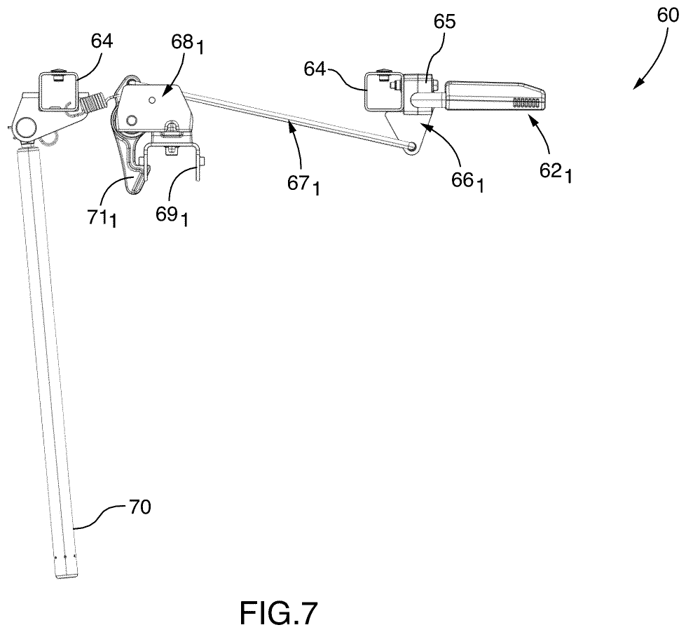

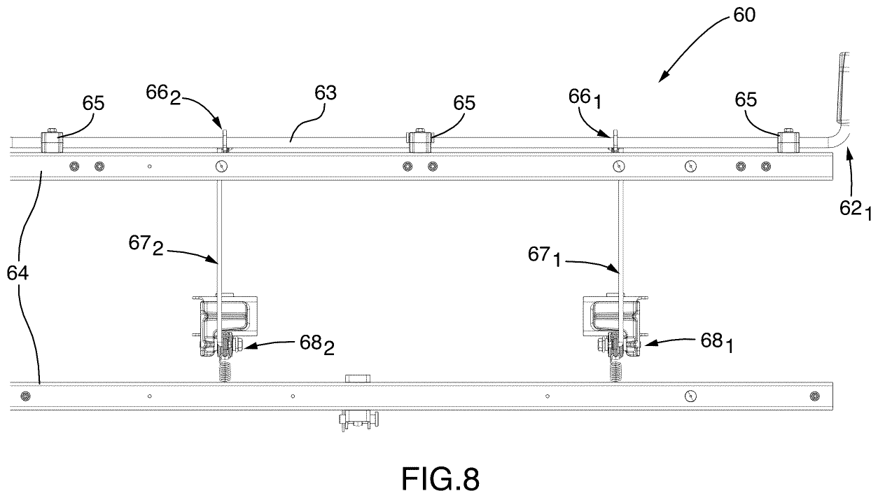

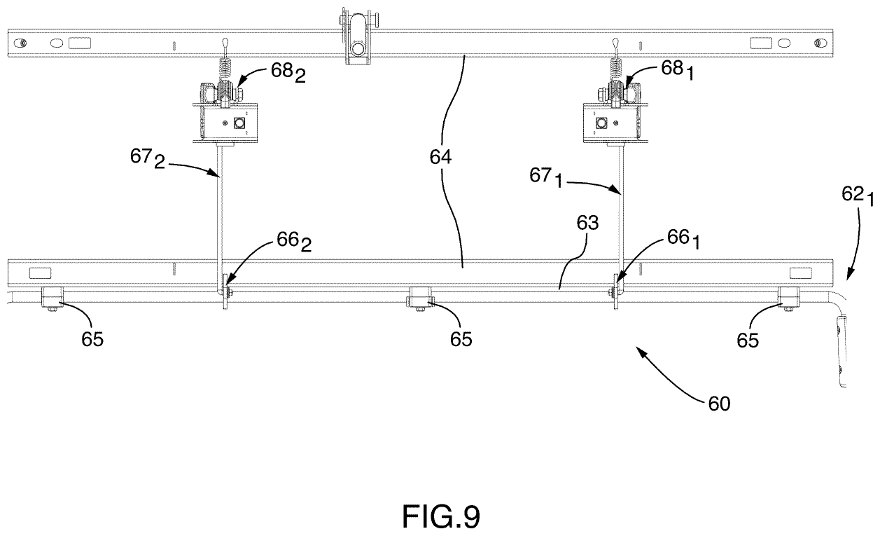

To secure the cargo box 50 to the frame 12 of the off-road vehicle 10 (in a horizontal or operational position), or to selectively release the cargo box 50 from the frame 12 of the off-road vehicle 10 (for example to move the cargo box 50 from the operational position into the release position), the off-road vehicle 10 comprises a latch assembly 60, as described further below in connection with FIGS. 3 to 16.

In this embodiment, the latch assembly 60 generally comprises an actuating portion, a latch portion and a transmission portion operatively connecting the actuating portion to the latch portion.

The actuating portion of the latch assembly 60 comprises two handles 61₁₋₂ located on opposite sides of the vehicle 10, the handles 61₁₋₂ being generally positioned in a vicinity of a front region of the cargo box 50. The handle 61₁ is a right side handle generally positioned along a right side of the off-road vehicle 10 and the handle 61₂ is a left side handle generally positioned along a left side of the off-road vehicle 10. The handles 61₁₋₂ generally extend along the longitudinal direction of the off-road vehicle 10.

The two handles 61₁₋₂ are generally positioned at a bottom portion of the base 200 of the cargo box 50, including in some embodiments below the base 200 of the cargo box 50, specifically below the cargo box supporting frame 58. Along the longitudinal direction of the off-road vehicle 10, the handles 61₁₋₂ are generally positioned behind (or rearward from) the seat 24, generally at the level of a backrest 25 of the seat 24. Specifically, the handles 61₁₋₂ are generally positioned behind (or rearward from) the front wall 202 of the cargo box 50, more specifically behind (or rearward from) the two planar surface 203₁₋₂ defined by the front wall 202 of the cargo box 50. Still in this embodiment, the handles 61₁₋₂ are positioned above the intermediate wheels 18, on either side of the off-road vehicle 10 (as best seen on FIG. 10).

The actuating portion (i.e., the handles 61₁₋₂) of the latch assembly 60 is connected to a transmission portion comprising a rod 63 extending generally laterally (i.e., the rod 63 is generally perpendicular to the longitudinal orientation of the two handles 61₁₋₂). Specifically, the handles 61₁₋₂ are connected one another by the rod 63, the rod 63 being itself affixed to each one of the handles 61₁₋₂ and being pivotally connected to a structural component of the cargo box 50, as further described below. More specifically, the rod 63 is bent at each one of its end portions to define at least part a core (and/or a longitudinal direction) of respective one of the handles 61₁₋₂.

In this embodiment, the cargo box supporting frame 58 comprises a plurality of support beams 64 (e.g., square beams) and the rod 63 is pivotally connected to one of the support beams 64 of the cargo box supporting frame 58 via a plurality of support structures 65 (or mounts). Three support structures 65 are used to connect the rod 63 to the support beam 64 in this embodiment, two of the support structures 65 being generally positioned along (and affixed to) a respective edge region of the support beam 64 and one of the support structures 65 being generally positioned in (and affixed to) a center region of the support beam 64.

The support structures 65 and the rod 63 enable a rotational (or pivotal) movement of the handles 61₁₋₂ relative to the support beam 64 (i.e., relative to the cargo box supporting frame 58/cargo box 50), and along an axis of rotation generally coextensive with an axis of the rod 63 along the lateral direction. It will be readily appreciated that any other suitable configuration of the support structures 65 (e.g., in terms of the number and/or position of the support structures 65 along the square beam 64) and/or the rod 63 (e.g., in terms of dimension and/or shape and/or configuration of the rod 63) may be used in other non-limiting embodiments. For instance, in this embodiment, each support structure 65 comprises two plastic components that are fastened to one another and to one of the support beam 64, such that the plastic components define a circular aperture through the support structure 65 for rotatably receiving the rod 63, and may be free of bearings. In other non-limiting examples, the support structures 65 may comprise bearings.

Still in this embodiment, the transmission portion further comprises two levers 66₁₋₂, each one of the levers 66₁₋₂ being affixed to the rod 63 at a respective edge portion of the levers 66₁₋₂ (e.g., each one of the two levers 66₁₋₂ defines an edge portion having a (circular) shape generally conforming to a cross-sectional shape of the rod 63, and accordingly being configured to engage the rod 63). Along the lateral direction, the levers 66₁₋₂ may be located generally midway between a middle portion of the rod 63, and a respective one of the handles 61₁₋₂. As such, the lever 66₁ is a right lever (positioned generally closer from the right handle 61₁ than from the left handle 61₂) and the lever 66₂ is a left lever (positioned generally closer from the left handle 61₂ than from the right handle 61₁). Any other suitable configuration of the levers 66₁₋₂ (e.g., in terms of the number of levers, the configuration of the levers and/or the position of the levers along the rod 63) may be possible in other non-limiting embodiments.

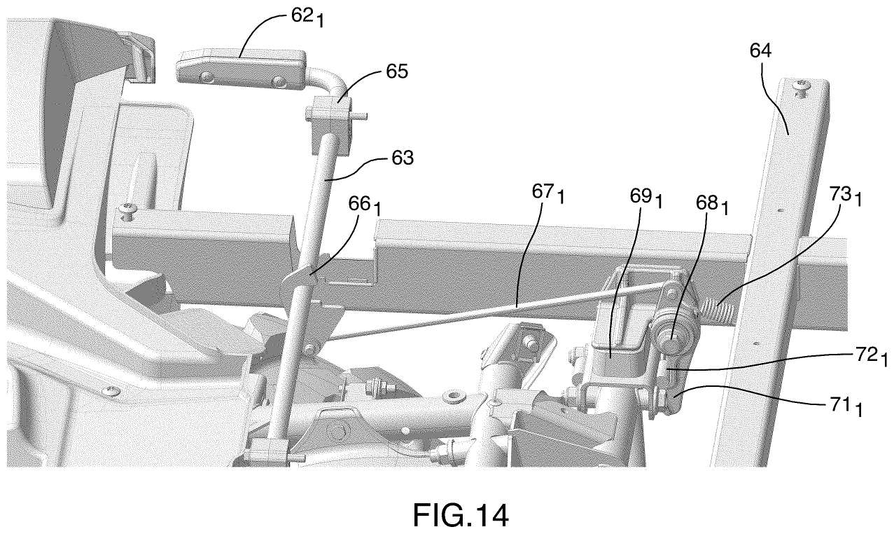

The transmission portion further comprises two links 67₁₋₂, each one of the two levers 66₁₋₂ being further pivotally connected to one of the two links 67₁₋₂ (for example, via a bearing). The links 67₁₋₂ extend longitudinally rearward and vertically upward towards an upper portion of one of two cams 68₁₋₂ (the link 67₁ and the cam 68₁ being a right link and a right cam, respectively, and the link 67₂ and the cam 68₂ being a left link and a left cam, respectively). As best shown in FIGS. 14 to 16, the cams 68₁₋₂ are also secured at one end to the cargo box supporting frame 58. Specifically, the cams 68₁₋₂ are pivotally connected to the supporting frame 58. More specifically, the cams 68₁₋₂ are pivotally connected to a bracket (in this case a L-bracket) that is itself affixed (e.g., fastened) to a longitudinal frame element of the cargo box supporting frame 58.

The cams 68₁₋₂ are each further pivotally connected to the cargo box supporting frame 58 (which comprises the plurality of support beams 64). Each one of the cams 68₁₋₂ selectively engages one of two supports 69₁₋₂, each one of the two supports 69₁₋₂ being secured to the frame 12 (i.e., to the rear frame portion 54) of the off-road vehicle 10. In other words, the cams 68₁₋₂ engage the frame 12 via the supports 69₁₋₂ to maintain or retain the cargo box 50 in the horizontal (or operational) configuration. The cams 68₁₋₂ are pivotable relative to respective one of the two supports 69₁₋₂ and pivotable relative to the frame 12 to lock the cargo box 50 in the horizontal (or operational) configuration/unlock the cargo box 50 from the horizontal (or operational) configuration. This may be achieved in a number of non-limiting ways, for example via a bearing generally positioned in an intermediate portion of the cams 68₁₋₂ and which enables rotational movement of the cams 68₁₋₂ relative to the supports 69₁₋₂, as well as the frame 12 of the off-road vehicle 10/rear frame portion 54, via the bearing.

In this embodiment, the latch portion of the latch assembly 60 is defined by the cams 68₁₋₂, each one of the cams 68₁₋₂ further comprising in a lower portion thereof a latch portion 71₁₋₂ (the latch portion 71₁ being a right latch portion and the latch portion 71₂ being a left latch portion), each one of the latch portions 71₁₋₂ being configured to selectively engage a corresponding protrusion 72₁₋₂ of the frame 12 of the off-road vehicle 10. In this embodiment, there are accordingly two protrusions, the protrusion 72₁ being a right protrusion and the protrusion 72₂ being a left protrusion, to lock the cargo box 50 in the horizontal/operating configuration relative to the frame 12/the rear frame portion 54, as further described below.

Still in this embodiment, the supports 69₁₋₂ which are selectively engageable with respective ones of the cams 68₁₋₂ comprise the protrusions 72₁₋₂ (specifically, the right support 69₁ comprises the right protrusion 72₁ and the left support 69₂ comprises the left protrusion 72₂), but this needs not be the case in other non-limiting embodiments, and in which any other protrusion or mating surface of the rear frame portion 54 of the off-road vehicle 10 may be used for selective engagement of the latch portions 71₁₋₂ (e.g., a rod, an underside of a beam or plate, etc.). It will also be readily appreciated that any other suitable configuration of the links 67₁₋₂ and the cams 68₁₋₂ (e.g., in terms of the number of links, cams and latch portions, the configuration of the links, the configuration of the cams, the location and the means of attachment of the links to the cams, the location and the means of attachment of the cams to the cargo box supporting frame 58 and/or the frame 12, the configuration of the latch portion, etc.) may be possible in other non-limiting embodiments.

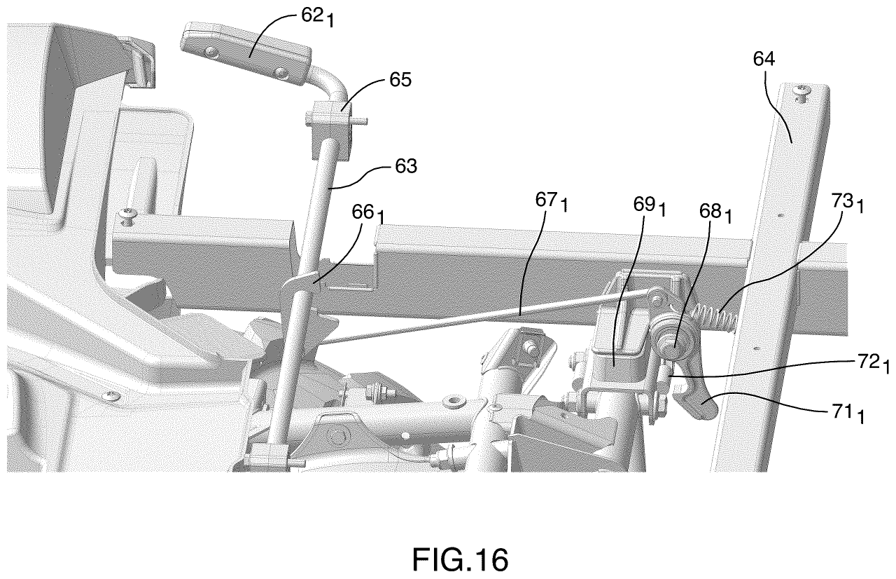

To promote an engagement of the latch portions 71₁₋₂ with the corresponding protrusions 72₁₋₂, spring assemblies 73₁₋₂ are secured to corresponding ones of the cams 68₁₋₂ via the upper region of respective cams 68₁₋₂, the spring assemblies 73₁₋₂ being further secured to one of the support beams 64 of the cargo box 50. As a result of the elastic force that is applied by the spring assemblies 73₁₋₂ between the support beam 64 and respective ones of the cams 68₁₋₂, and absent the exertion of any (upward) force onto the handles 61₁₋₂ by a user, the latch portions 71₁₋₂ of the cams 68₁₋₂ remain engaged with the corresponding protrusions 72₁₋₂ of the frame 12 (i.e., the rear frame portion 54) of the off-road vehicle 10, thereby locking the cargo box 50 in position and preventing any pivotal movement of the cargo box 50 relative to the frame 12 around the axis of rotation 180 (and as shown in FIG. 16).

When the handles 61₁₋₂ are in a horizontal position, as a result of the elastic force exerted by the spring assemblies 73₁₋₂, the protrusions 72 of the frame 12 of the off-road vehicle 10 engage the corresponding latch portions 71 of the cams 68₁₋₂, thereby preventing the cargo box 50 from being releasable from the frame 12 (i.e., from engaging into a pivotal movement around the axis of rotation 180). In other words, as a result of the force exerted by the spring assemblies 73₁₋₂ the latch assembly 60 is spring loaded to promote a locked (i.e., horizontal/operating) configuration of the cargo box 50.

It will be readily appreciated that, in the embodiment of FIGS. 14 to 16, as a result of the configuration of the cams 68₁₋₂ (and the latch assembly 60 more generally) the elastic force that is applied by the spring assemblies 73₁₋₂ should be a rearward force (exerted on an upper end portion of the cams 68₁₋₂) for the latch portions 71₁₋₂ of the cams 68₁₋₂ to remain engaged with the corresponding protrusions 72₁₋₂ of the frame 12. However, this needs not be the case in other non-limiting embodiments.

The latch assembly 60 accordingly comprises a cargo box portion and a frame portion. The cargo box portion of the latch assembly 60 comprises the handles 61₁₋₂, the rod 63, the levers 66₁₋₂, the links 67₁₋₂, the cams 68₁₋₂ comprising the latch portions 71₁₋₂ and the spring assemblies 73₁₋₂. In other words, once the cargo box 50 pivots around the axis of rotation 180, all the elements of the cargo box portion of the latch assembly 60 also pivot along with the cargo box 50, as these elements are generally secured/affixed to the cargo box supporting frame 58. The frame portion of the latch assembly 60 comprises the supports 69₁₋₂ (along with the corresponding protrusions 72₁₋₂ in this embodiment). In other words, once the cargo box 50 pivots around the axis of rotation 180, the elements of the frame portion of the latch assembly 60 do not pivot around the axis of rotation 180, as these elements are generally secured/affixed to the frame 12 of the off-road vehicle 10, specifically to the rear frame portion 54.

In this embodiment, the transmission and latch portions of the latch assembly 60 (i.e., the rod 63, the levers 66₁₋₂, the links 67₁₋₂, the cams 68₁₋₂ and the spring assemblies 73₁₋₂) are positioned longitudinally behind (or rearward from) the handles 61₁₋₂. In other words, the transmission and latch portions of the latch assembly 60 are positioned behind (or rearward from) the actuating portion of the latch assembly 60 along the longitudinal direction of the off-road vehicle 10, generally below the cargo box 50.

This configuration of the latch assembly 60, in which the latch assembly 60 is generally coextensive with the cargo box supporting frame 58 of the off-road vehicle 10, and which generally extends behind (or rearward from) the seat 24/front wall 202 of the cargo box 50 and below the cargo box 50, enables its use within the configuration of the off-road vehicle 10, and in which the main frame portion 52 of the off-road vehicle 10 to which the front and intermediate wheels 16, 18 are connected to generally provides no space to accommodate a latch assembly at a forward end of the cargo box 50.

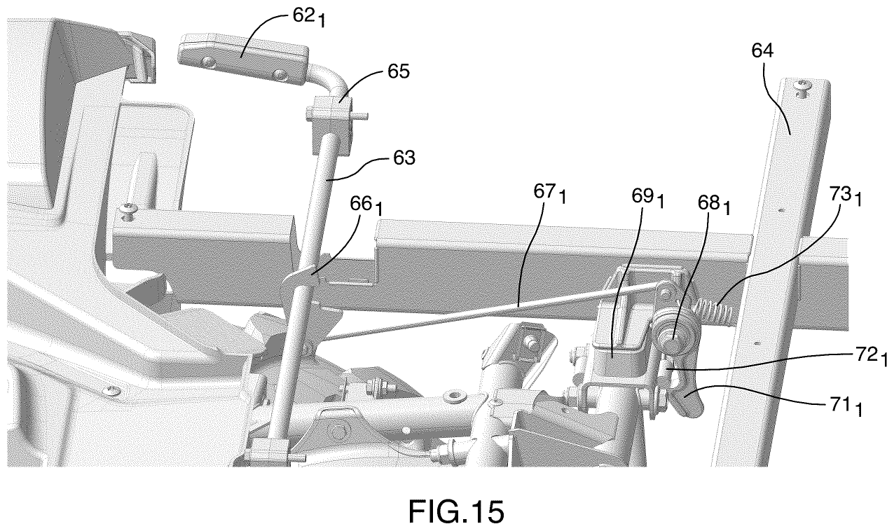

In use, and with reference to FIGS. 15 and 16, as user applies an upward force onto either one of the handles 61₁₋₂, such force (and the associated movement of the handles 61₁₋₂) causes in turn: (i) a rotation of the rod 63 and the levers 66₁₋₂ affixed thereto (the rod 63 and the levers 66₁₋₂ rotate in a clockwise fashion as seen from a left side of the off-road vehicle 10, as well as in a reverse clockwise fashion as seen from a right side of the off-road vehicle 10); (ii) a forward translational movement of the links 67₁₋₂ relative to the frame 12 of the off-road vehicle 10, along a longitudinal direction of the off-road vehicle 10—it will be readily appreciated that this translational movement counteracts the (rearward) elastic force that is applied by the spring assemblies 73₁₋₂ between the support beam 64 and respective ones of the cams 68₁₋₂); (iii) a rotation of the cams 68₁₋₂ and respective latch elements 71₁₋₂ around the bearing of the cams 68₁₋₂ (the cams 68₁₋₂ rotate in a clockwise fashion as seen from a left side of the off-road vehicle 10, as well as in a reverse clockwise fashion as seen from a right side of the off-road vehicle 10), thereby disengaging the latch portions 71₁₋₂ from the corresponding protrusions 72₁₋₂ of the frame 12 of the off-road vehicle 10. Once the latch portions 71₁₋₂ have been disengaged from the corresponding protrusions 72₁₋₂ of the frame 12, the cargo box 50 is now free to rotate around the axis of rotation 180. For example, the user can apply a further upward force onto the handles 61₁₋₂ resulting in the cargo box 50 transitioning from a horizontal configuration (as shown in FIG. 17) to an angled configuration (as shown in FIG. 18).

In the previous description, non-limitative embodiments of the method are described. Although these embodiments of the assembly and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the method, as will be briefly explained herein and as can be easily inferred herefrom by a person skilled in the art. Moreover, it will be appreciated that positional descriptions such as “above”, “below”, “left”, “right”, “bottom”, “top”, “end” and the like should, unless otherwise indicated, be taken in the context of the figures and should not be considered limiting.

Furthermore, in the previous description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only.

In the present description, an embodiment is an example or embodiment. The various appearances of “one embodiment”, “one embodiment”, “an embodiment” or “some embodiments” do not necessarily all refer to the same embodiment or embodiment. Although various features may be described in the context of a single embodiment, the features may also be provided separately or in any suitable combination. Conversely, although the invention may be described herein in the context of separate embodiments for clarity, it may also be implemented in a single embodiment. Reference in the specification to “some embodiments”, “an embodiment”, “one embodiment” or “other embodiments” means that a particular feature, structure, or characteristic described in connection with the embodiments or embodiment is included in at least some embodiments, but not necessarily all embodiments.

It is to be understood that the phraseology and terminology employed herein are not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in embodiments other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not to be construed that there is only one of that element. It is to be understood that where the specification states that a component, feature, structure, or characteristic “may”, “might”, “can” or “could” be included, that particular component, feature, structure, or characteristic is not required to be included.

Several alternative embodiments, embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited solely by the scope of the appended claims.

1. A latching assembly for a cargo box for a vehicle, the latch assembly comprising an actuating portion configured to be actuated by a user, a latch portion configured to selectively engage a portion of a frame of the vehicle to selectively lock the cargo box on the vehicle in an operating position, and a transmission portion to operatively connect the actuating portion to the latch portion, wherein the actuating portion and the latch portion are spaced from one another in a longitudinal direction of the cargo box.

2. The latch assembly of claim 1, wherein the actuating portion comprises at least one handle.

3. The latch assembly of claim 2, wherein the actuating portion comprises two handles.

4. The latch assembly of claim 1, wherein the actuating portion is positioned in a vicinity of a front portion of the cargo box.

5. The latch assembly of claim 1, wherein the transmission portion comprises a rod extending generally laterally between a left side and a right side of the vehicle.

6. The latch assembly of claim 5, wherein the transmission portion is affixed to the actuating portion.

7. The latch assembly of claim 6, wherein the transmission portion comprises at least one lever affixed to the rod.

8. The latch assembly of claim 7, wherein the transmission portion comprises two levers affixed to the rod.

9. The latch assembly of claim 7, wherein the transmission portion further comprises a link connected to the at least one lever.

10. The latch assembly of claim 9, wherein the link extends longitudinally toward a rear section of the cargo box.

11. The latch assembly of claim 9, wherein the link is connected to a cam.

12. The latch assembly of claim 11, wherein the cam comprises the latch portion.

13. The latch assembly of claim 1, wherein the latch assembly further comprises a spring.

14. The latch assembly of claim 1, wherein the cargo box is pivotally connected to the frame of the vehicle at a rear end portion of the cargo box.

15. The latch assembly of claim 14, wherein the latch assembly enables pivotal movement of the cargo box relative to the frame of the vehicle.

16. A 6×6 vehicle comprising a frame, a front pair of ground-engaging members, an intermediate pair of ground-engaging members and a rear pair of ground-engaging members, the frame comprising: (i) a main portion extending from a front of the vehicle to the intermediate pair of ground-engaging members; and (ii) a rear portion extending from the intermediate pair of ground-engaging members to the rear pair of ground-engaging members,
wherein the main portion and the rear portion are affixed to one another through a connection portion, the connection portion comprising an upper connection portion and a lower connection portion, and wherein the main portion supports a drivetrain, a rear differential, an exhaust system comprising a muffler and an exhaust outlet, and a suspension system of the intermediate pair of ground-engaging members, wherein at least one component of the drivetrain, the rear differential, the exhaust system and the suspension system of the intermediate pair of ground-engaging members is adjacent and at least partly in front of the upper connection portion.

17. The 6×6 vehicle of claim 16, wherein the upper connection portion comprises a left upper connection portion and a right upper connection portion spaced from the left upper connection portion in a lateral direction of the 6×6 vehicle, and the component spans at least 90% of a lateral distance between the left upper connection portion and the right upper connection portion.

18. The 6×6 vehicle of claim 16, wherein the component is at least partly rearward from the lower connection portion.

19. The 6×6 vehicle of claim 18, wherein the component is entirely rearward from the lower connection portion.

20. The 6×6 vehicle of claim 19, wherein the component is a muffler.
